(19) United States
(12) Patent Application Publication
(10) Pub. No.: US 2016/0317369 A1
(43) Pub. Date: Nov. 3, 2016

(54) "P.C. BUBBLE" PROTECTIVE BUBBLE FOR MOBILITY VEHICLE

(71) Applicant: Crescia E. Hagler, St. Paul, MN (US)

(72) Inventor: Crescia E. Hagler, St. Paul, MN (US)

(21) Appl. No.: 15/082,804

(22) Filed: Mar. 28, 2016

Related U.S. Application Data
(60) Provisional application No. 62/179,159, filed on Apr. 30, 2015.

(51) Int. Cl. A61G 5/10

(52) U.S. Cl. CPC A61G 5/10

(57) ABSTRACT

A mobility vehicle including a wheeled frame having two front wheels and two rear wheels; a seat disposed at a widthwise center of the mobility vehicle over the front wheels and the two rear wheels; a first mounting member mounted between a first front wheel and a first rear wheel on a first side of the mobility vehicle; a second mounting member mounted between a second front wheel and a second rear wheel on a second side of the mobility vehicle parallel to the first side of the mobility vehicle; and a protection system mounted to the first mounting member and to the second mounting member and providing cover over the seat.

### CROSS-REFERENCE TO RELATED APPLICATIONS

This patent application claims the benefit of priority, under 35 U.S.C. 119(e), to U.S. Provisional Patent Application Ser. No. 62/179,159, entitled “P.C. (POWER CHAIR/SCOOTER) BUBBLE,” filed on Mar. 31, 2015, which is herein incorporated by reference in their entirety.

### TECHNICAL FIELD

Embodiments relate to wheelchairs, power chairs, or scooters. Specifically, some embodiments relate to covers for fitting onto power chairs, wheelchairs, or scooters, to shield the occupant from outdoor weather elements such as sun, rain, wind, hail, snow, etc.

### BACKGROUND

Wheelchairs, power chairs, and other similar vehicles are frequently used to provide mobility for a person who has a limited ability to walk either temporarily or permanently. Operation outdoors creates the need for enhanced shade or shelter.

### BRIEF DESCRIPTION OF THE DRAWINGS

FIG. 1A is a side view of a mounting mechanism for a protective cover in accordance with various embodiments.

FIG. 1B illustrates a rear coupling mechanism for the mounting mechanism of a protective cover in accordance with various embodiments.

FIG. 1C illustrates a front coupling mechanism for the mounting mechanism of a protective cover in accordance with various embodiments.

FIG. 1D is a side view of a protective cover in accordance with various embodiments.

FIG. 2. is a perspective view of a power chair in accordance with some embodiments.

FIG. 3 is a perspective view of a power chair having a protective cover attached in accordance with various embodiments.

FIG. 4 is a front view of a power chair having a protective cover attached in accordance with various embodiments.

FIG. 5 illustrates a rear-wheel fastener for attaching a protective cover in accordance with various embodiments.

### DETAILED DESCRIPTION

Embodiments provide for a bubble-like covering, attachable and adaptable to electric motorized wheelchairs, power chairs, scooters, etc. to provide protection to the occupant from weather events such as sun, wind, rain, hail, and snow. This bubble-like covering can be referred to as a P.C. Bubble™ available from Crescia Hagler of St. Paul, Minn.

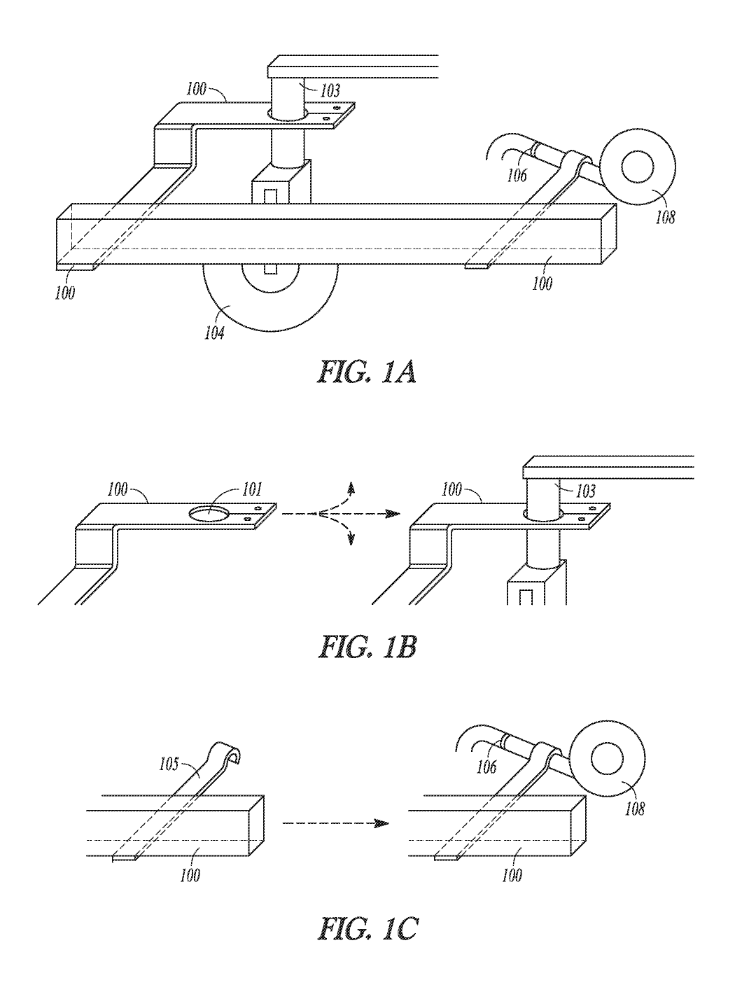

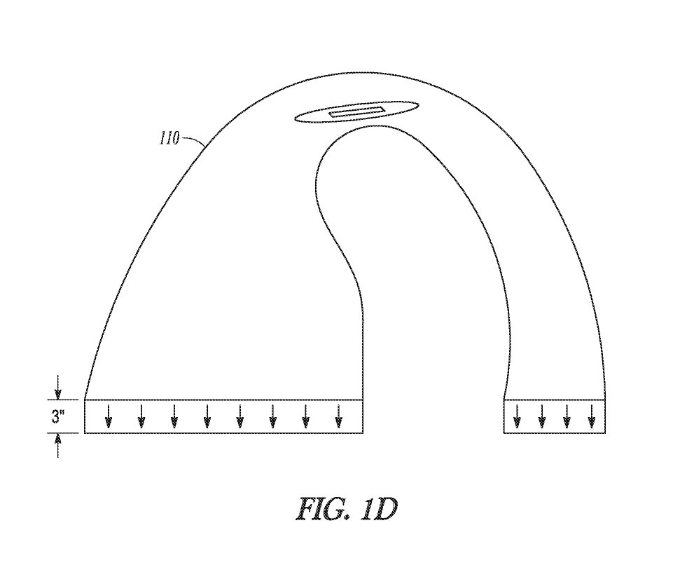

FIG. 1A is a side view of a mounting mechanism 100 for a protective cover in accordance with various embodiments. Preformed, rectangular mounting mechanism 100 is approximately 48 inches long, 4 inches deep, and 2 inches wide with longitudinal grooves cut down the center. The groove is about 3 inches deep. Any dimensions described are examples only and not intended to limit the embodiments described herein. For example, dimensions measured herein may apply to some models of power chairs, electric wheelchairs, scooters, etc., while different dimensions will apply to other models.

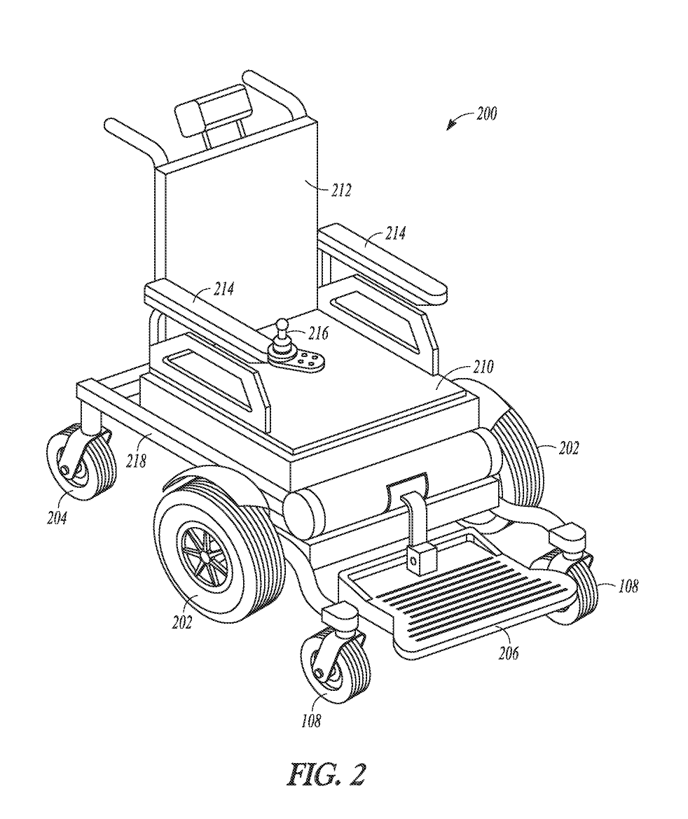

The mounting mechanism 100 does not touch the ground, and extends out from one side of the power chair 200 (FIG. 2) laterally. As will be appreciated (although not shown in FIG. 1A) another pre-formed and attached protective cover holder will be provided in various embodiments on the other side of a power chair 200.

FIG. 1B illustrates a rear coupling mechanism for the mounting mechanism 100 of a protective cover in accordance with various embodiments. As shown in FIG. 1B, the mounting mechanism 100 includes a rear wheel bracket with a flexible opening 101 that can be attached around tubular portions 103 of the rear wheel 104 mechanism. FIG. 1C illustrates a front coupling mechanism for the mounting mechanism 100 of a protective cover in accordance with various embodiments. As shown in FIG. 1C, the mounting mechanism 100 also attaches using member 105 at the front of the power chair at front extensions 106, which may include or be part of anti-tip wheels 108.

FIG. 1D is a side view of a protective cover 110 in accordance with various embodiments. As shown in FIG. 1D, the protective cover 110 can be a pre-formed, single unit of lightweight, clear, scratch proof, waterproof, UV-protected industrial plastic that is mounted over a power chair 200 as depicted later herein, or at least somewhat similarly to that depicted, after the plastic mounting mechanism 100 have been securely attached to the power chair as shown in FIGS. 1B and 1C and inserted down inside the pre-cut longitudinal grooves of the plastic mounting mechanism 100, on each side of the power chair 200.

FIG. 2 is a front view of a power chair 200 in accordance with some embodiments. The power chair 200 includes a pair of right and left front wheels 202 and a pair of right and left rear wheels 204 and is thus four-wheeled, although some embodiments can include anti-tip wheels 108. Some or all wheels may be caster wheels. The front wheels 202 are steered wheels while the rear wheels 204 are driving wheels. The front wheels 202 can have a diameter larger than that of the rear wheels 204 although embodiments are not limited thereto,

Flat floor 206 for resting the feet of a driver is provided between the front wheels 202. The seat 210 is disposed at a widthwise center between and above the wheels 204, 202. A backrest 212. rising from a rear part of the seat 210 for supporting the back of the driver. The power chair 200 can include armrests 214 and a steering mechanism 216. A frame 218 provides support and interconnection between the front wheels 202 and the rear wheels 204. Anti-tip wheels 108 can also be provided.

Thousands of individuals depend daily upon motorized electric wheel and/or power chairs, such as the power chair 200 shown in FIG. 2, to transport themselves outside their homes to conduct normal personal affairs such as working, shopping, appointments, recreation, etc. Use of power chairs 200 enable individuals to live independent lifestyles. However, sonic motorized power chairs 200 do not currently provide protection from a variety of adverse weather events.

The embodiments described above provide cover and protection for individuals whose daily mobility depends on the use of a vehicle such as the power chair 200. Some available covers do not provide sufficient protection, durability, or visibility. Embodiments address these and other concerns through use of a translucent or transparent, durable, preferably hard plastic cover (e.g., a “bubble”) that can be easily detached from the power chair 200 for added convenience for the user or for caregivers.

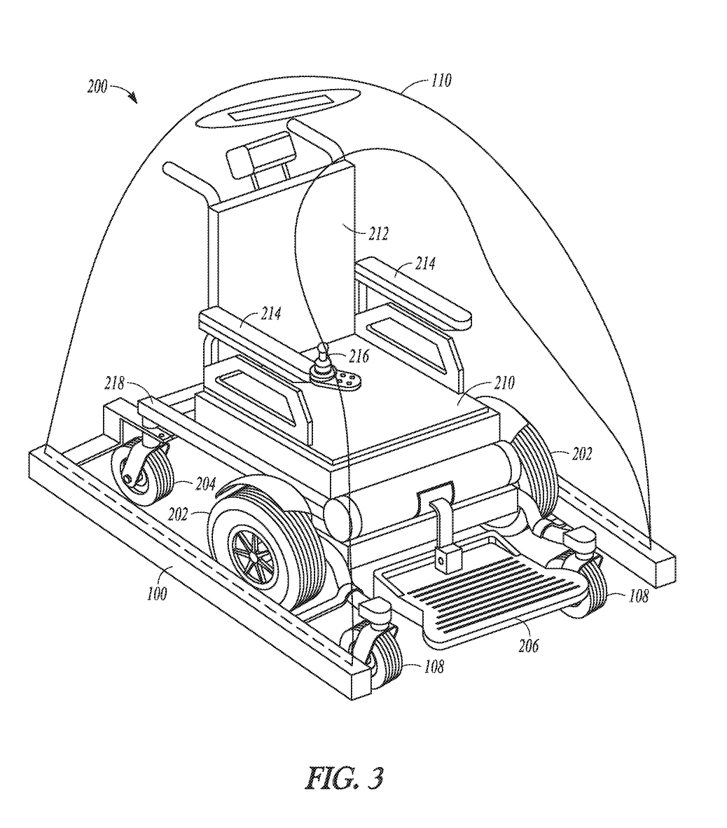

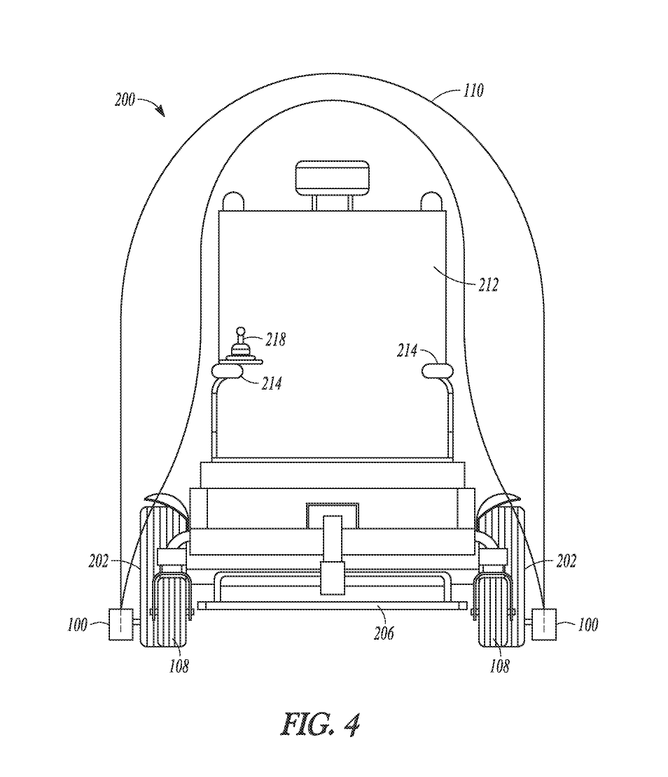

FIG. 3 is a perspective view of a power chair 200 having a protective cover 110 attached/detached in accordance with various embodiments using mechanisms described above with respect to FIGS. 1A-1D. In alternative embodiments, the mounting mechanism 100 can be arranged in a circular or semicircular fashion around the power chair 200. In some embodiments, the protective cover 110 may comprise two or more pieces to fit over separate halves of the power chair 200. In some embodiments, separate, heavy duty, metal connectors can securely snap over anti-tip wheels 108, and additional heavy-duty metal connectors can extend underneath the power chair 200 to provide further stability. Additional connectors could extend vertically, for example from a middle portion of the mounting mechanism 100, to secure to an armrest or other upper portion of the power chair 200 for additional stability.

FIG. 4 is a front view of the power chair 200 having a protective cover 110 attached according to various embodiments. As depicted, a mounting mechanism 100 is attached on either side of the power chair 200.

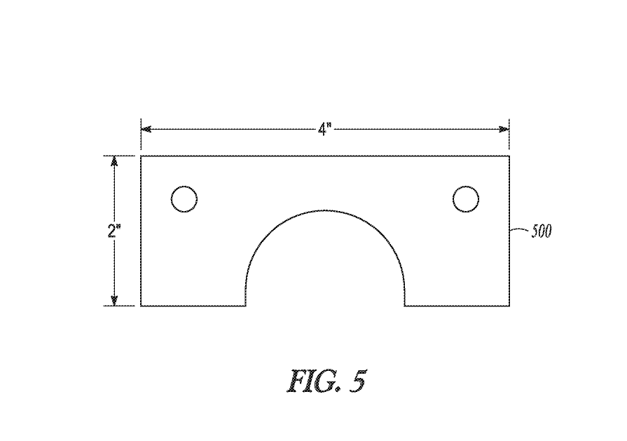

FIG. 5 illustrates a rear-wheel fastener 500 for attaching a protective cover in accordance with various embodiments. The rear wheel fastener 500 can be four inches long and 2 inches high, although embodiments are not limited thereto. The rear wheel fastener 500 can connect to a rear wheel 104 of the power chair 200.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

1. A mobility vehicle comprising:
a wheeled frame having two front wheels and two rear wheels;
a seat disposed at a widthwise center of the mobility vehicle over the front wheels and the two rear wheels;
a mounting mechanism including a first mounting member mounted between a first front wheel and a first rear wheel on a first side of the mobility vehicle;
a second mounting member mounted between a second front wheel and a second rear wheel on a second side of the mobility vehicle parallel to the first side of the mobility vehicle; and
a protection system mounted to the first mounting member and to the second mounting member and providing cover over the seat.

2. The mobility vehicle of claim 1, wherein the mobility vehicle is a power chair.

3. The mobility vehicle of claim 1, wherein the first mounting member and the second mounting member are comprised of plastic.

4. The mobility vehicle of claim 1, wherein the first mounting member and the second mounting member are comprised of metal.

5. The mobility vehicle of claim 1, further comprising a first fastener to fasten the protection system to the first rear wheel and a second fastener to fasten the protection system to the second rear wheel.

6. The mobility vehicle of claim 1 wherein the protection system is fabricated using impermeable materials and joinery methods.

7. The mobility vehicle of claim 1 wherein the protection system is open at front viewing window at a front portion of the mobility vehicle for allowing a viewing area to the outside through the protection system.

8. The mobility vehicle of claim 7, further comprising a front flap over the front viewing window.

9. The mobility vehicle of claim 8, wherein the front flap is detachable from the protection system.

10. A protection system comprising:
a first bracket having a first end configured to be secured, along a first plane, to a first rollable mechanism and a second end configured to be secured along the first plane to a second rollable mechanism;
a second bracket configured to be secured, along a second plane parallel to the first plane, to a third rollable mechanism and a second end configured to be secured along the second plane to a fourth rollable mechanism; and
a protective cover configured to couple to the first bracket and the second bracket and having a first vertical portion perpendicular to the first bracket, a second vertical portion perpendicular to the second bracket, and a generally horizontal portion between the first vertical portion and the second vertical portion.

11. The protection system of claim 10, wherein the first and second brackets include an length adjustment for adjusting a length of the first and second brackets relative to distances between respective first rollable mechanism, second rollable mechanism, third rollable mechanism, and fourth rollable mechanism.

12. The protection system of claim 10, wherein the protection system is comprised of plastic.

13. The protection system of claim 12, wherein the protection system is waterproof.

14. The protection system of claim 12, wherein the protection system is transparent.

15. The protection system of claim 12, wherein the protection system is arranged to provide 360-degree visibility.

16. The protection system of claim 12, wherein the protection system is constructed of UV-protected plastic.

17. The protection system of claim 12, wherein the protection system is scratch-resistant.

18. The protection system of claim 10, wherein the first bracket and the second bracket are comprised of plastic.

19. The protection system of claim 10, wherein the first bracket and the second bracket are comprised of metal.

20. The protection system of claim 10, further comprising a rear wheel fastener fasten the protection system to a rear wheel of the wheelchair.
